(19) United States
(12) Patent Application Publication
(10) Pub. No.: US 2009/0232301 A1
(43) Pub. Date: Sep. 17, 2009

(54) METHOD AND SYSTEM FOR GENERATING SESSION KEY, AND COMMUNICATION DEVICE

(76) Inventor: Chunqiang LI, Shenzhen (CN)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/473,371

(22) Filed: May 28, 2009

Related U.S. Application Data
(63) Continuation of application No. PCT/CN2008/070385, filed on Feb. 29, 2008.

(30) Foreign Application Priority Data
Mar. 21, 2007 (CN) 200710087225.5

(51) Int. Cl. H04L 9/06

(52) U.S. Cl. 380/44

(57) ABSTRACT

A method for generating a session key, a system, and a communication device are disclosed. The method includes: selecting, by a communication party, a temporary private key, and operating at least the temporary private key according to the parameters of the cryptosystem to generate a first message, and sending the first message to the opposite party; and after receiving the second message, operating, by the communication party, at least the second message and the temporary private key according to the parameters of the cryptosystem to generate a session key. The system includes a key management center and a communication device. The communication device includes: a temporary private key selecting unit, a message generating and sending unit, and a session key generating unit. In the disclosure, the session key generated after the communication party selects a temporary private key is variable, thus avoiding too much dependence on the key management center and improving the practicability and security of the key.

### CROSS-REFERENCE TO RELATED APPLICATIONS

This application is a continuation of International Patent Application No. PCT/CN2008/070385, filed on Feb. 29, 2008, which claims the benefit of priority to Chinese Patent Application No. 200710087225.5, filed with the Chinese Patent Office on Mar. 21, 2007, and entitled “METHOD AND SYSTEM FOR GENERATING SESSION KEY, AND COMMUNICATION DEVICE”, the contents of both of which are incorporated herein by reference in their entireties.

### FIELD OF THE DISCLOSURE

The disclosure relates to network communication, and in particular, to a method and system for generating a session key, and a communication device.

### BACKGROUND

In order to manage the public key effectively and certify the attribution relation between the owners of the public key and the public-private key pair, a digital certificate mechanism is applied. In the current network security, the Public Key Infrastructure (PKI) system uses a digital certificate mechanism to perform public key management. A Certification Authority (CA) organization responsible for issuing the public key certificate exists in the PKI system. The operation of the PKI system needs to be supported by a hierarchical CA and an online running certificate repository. The online running of the certificate repository occupies network bandwidth. Massive key management reduces the system performance, and gradually becomes a more and more noticeable problem of network security.

Currently, the key is bound to the key owner identifier in two modes. The first mode is: The key owner identifier is generated through the key. The Cryptographically Generated Address (CGA) is typical of this mode. The second mode is: The key corresponding to the identifier is determined through the identifier, namely, Identifier-Based Cryptography (IBC). There is a new public key management system—Identity-Based Encryption (IBE). In the IBE, the public key is not necessarily obtained from the public key certificate repository that runs online. Instead, a string, indicative of the user identity such as name, email address, and IP address, is used as a public key directly. The IBE needs no public key certificate or the relevant operation, thus simplifying the use and management of the public key.

For example, in the IBE-based security email system currently, the email account of the user or a derivative thereof may serve as a public key of the user. Generally, the account of the user is constant in a long term, and the corresponding public key does not change. Therefore, for two users who communicate frequently, the key used by them for encrypting the email does not change. Generally, if a key remains unchanged in a long term, the security of the key is reduced.

In the prior art, a Combined Public Key (CPK) cryptography is also provided. The CPK is also an identifier-based key management system, and is based on Public Key factor Matrixes (PKMs) and Secret/private Key factor Matrixes (SKMs). In this solution, a trustworthy key management center exists, which is responsible for generating PKMs and SKMs. The PKMs are open in the system, and the SKMs are in the custody of the key management center.

The key management center calculates the factors that constitute the private key of the user according to the user identifier and a mapping algorithm, calculates the private key of the user according to the private key factors, and delivers the private key together with the system parameters and the PKM to the user securely.

Afterward, according to the determined PKM, the communicating party calculates the public key of each user according to the user identifier and the corresponding mapping algorithm. For example:

$$SKM = [ \begin{matrix}{S}_{0 , 0} & {S}_{0 , 1} & … & {S}_{0 , N - 1} \\ {S}_{1 , 0} & {S}_{1 , 1} & … & {S}_{1 , N - 1} \\ … & … & … & … \\ {S}_{M - 1 , 0} & {S}_{M - 1 , 1} & … & {S}_{M - 1 , N - 1}\end{matrix} ]$$

$$PKM = [ \begin{matrix}{P}_{0 , 0} & {P}_{0 , 1} & … & {P}_{0 , N - 1} \\ {P}_{1 , 0} & {P}_{1 , 1} & … & {P}_{1 , N - 1} \\ … & … & … & … \\ {P}_{M - 1 , 0} & {P}_{M - 1 , 1} & … & {P}_{M - 1 , N - 1}\end{matrix} ]$$

Both parties to a communication calculate the shared key according to the public key of the user, the private key of each party, and the corresponding key exchange algorithm (such as the Diffie-Hellman key exchange algorithm based on the discrete logarithm and the elliptic curve). The calculation based on the following assumptions: Both parties to the communication are A and B, the key exchange algorithm based on the discrete logarithm is applied, and the system parameter is (p, g), where p is a prime number, g is a generator of the finite field Fp, and g is smaller than p.

Party A and party B may calculate the public key of the opposite party according to the corresponding mapping algorithm and the PKM, and may calculate a shared key according to the key exchange algorithm and their own private key.

In the process of implementing the disclosure, it may be found that, when both communication parties use their own private key and the public key of the opposite party to calculate the corresponding shared key, the calculated shared key keeps unchanged in a long term. That is because the public key and the private key for calculating the shared key of both parties remain unchanged in the long term, the identifier of the communication entity decides their corresponding public-and-private key pair, and the identifier of the communication entity remains unchanged in a long term.

### SUMMARY

Considering that the security in the identity-based combined key management system in the prior art is low because the calculated shared key remains unchanged in the long term, a method and system for generating a session key, and a communication device are provided in various embodiments of the disclosure. The technical solution is as follows.

A method for generating a session key is provided in an embodiment of the disclosure. [symbol] cryptosystem, the method includes: selecting, by a first communication party, a first temporary private key, operating at least the first temporary private key according to parameters of the cryptosystem, and sending a first message to a second communication party; and operating at least a second message and the first temporary private key according to the parameters of the cryptosystem to generate the first session key after receiving the second message, where the second message is generated by the second communication party after at least the second temporary private key selected by the second communication party is operated according to the parameters of the cryptosystem.

A system for generating a session key is provided in an embodiment of the disclosure. The system is a cryptosystem, and includes: a key management center adapted to generate a long-term public key and a long-term private key according to the parameters of the cryptosystem, and send the long-term private key to the first communication device securely; and first communication device of a first communication device adapted to select a temporary private key; operate at least the temporary private key according to the parameters of the cryptosystem to generate a local message; send the local message to a second communication device of a second communication device; operate at least the received opposite message and the temporary private key according to the parameters of the cryptosystem to generate a session key, where the opposite message is generated by the second communication device after at least the temporary private key selected by the second communication device is operated according to the parameters of the cryptosystem.

A communication device is provided in an embodiment of the disclosure. Based on a cryptosystem, the communication device includes: a temporary private key selecting unit adapted to select a temporary private key; a message generating and sending unit adapted to: operate at least the temporary private key selected by the temporary private key selecting unit according to parameters of the cryptosystem to generate a local message, and send the local message to the opposite communication device; and a session key generating unit, adapted to: operate at least the received opposite message and the temporary private key selected by the temporary private key selecting unit according to the parameters of the cryptosystem to generate a session key, where the opposite message is generated by the opposite communication device after at least the temporary private key selected by the opposite communication device is operated according to the parameters of the cryptosystem.

The technical solution under the disclosure brings the following benefits: The session key, generated after the communication party selects a temporary private key, is variable, thus avoiding too much dependence on the key management center and improving the practicability and security of the key.

### BRIEF DESCRIPTION OF THE DRAWINGS

FIG. 1 is a flowchart of a method for generating a session key provided in the first embodiment of the disclosure;

FIG. 2 is a flowchart of a method for generating a session key provided in the second embodiment of the disclosure;

FIG. 3 is a flowchart of a method for generating a session key provided in the third embodiment of the disclosure;

FIG. 4 is a flowchart of a method for generating a session key provided in the fourth embodiment of the disclosure;

FIG. 5 shows a structure of a system for generating a session key provided in the fifth embodiment of the disclosure;

FIG. 6 shows a structure of a communication device provided in the sixth embodiment of the disclosure; and

FIG. 7 shows another structure of a communication device provided in the sixth embodiment of the disclosure.

### DETAILED DESCRIPTION

The disclosure is detailed below by reference to accompanying drawings and exemplary embodiments, but the disclosure is not limited to the embodiments disclosed herein.

In the identifier-based key management system provided in an embodiment of the disclosure, the communication party selects its own temporary private key to generate a session key through message exchange. Therefore, it is avoided that the shared key remains unchanged in a long term and the communication entity depends on the key management center excessively.

This embodiment supposes that both parties communicate with each other. In the identifier-based key management system, the PKM of the system is the PKM in the prior art, and the SKM of the system is the SKM in the prior art; party A and party B to the communication have their own private key (the private key is generated by the private key management center, and distributed to the corresponding communication entity securely) and public parameters of the system (including PKM); party A and party B may calculate out the long-term public key of the opposite party according to the identifier of the opposite party and the PKM of the system. That is, the user name is mapped according to a mapping algorithm to obtain N mapping value, and then the public key of the user is calculated out in the combined mode.

The communication party may be a communication device or communication terminal.

### Embodiment 1

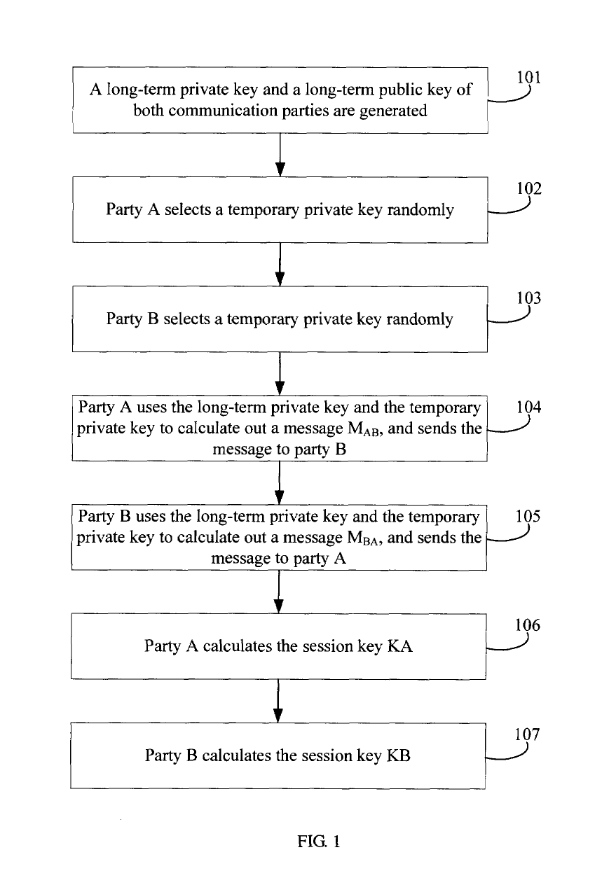

FIG. 1 is a flowchart of a method for generating a session key. In the cryptosystem based on the discrete logarithm in this embodiment, the system parameter T={g, p}, where p is a prime number, g is a generator of the finite field Fₚ, and g is smaller than p.

The method for generating the session key between party A and party B includes:

Step 101: The key management center generates the long-term private key “a” of party A, long-term private key “b” of party B, long-term public key of party A: P_{A}=g^{a} mod p, and long-term public key of party B: P_{B}=g^{b} mod p, and sends a and b to party A and party B, respectively, in a secure mode.

Step 102: Party A selects a temporary private key “x” randomly, and stores it secretly.

Step 103: Party B selects a temporary private key “y” randomly, and stores it secretly.

Step 104: Party A calculates M_{AB}=(PB) ax mod p=gabx mod p, and sends the message M_{AB} to party B.

Step 105: Party B calculates M_{BA}=(PA)^{by} mod p=g^{aby} mod p, and sends the message M_{BA} to party A.

Step 106: After receiving the message M_{BA} sent by party B, party A calculates the session key K_{A}.

K_{A}=(M_{BA})^{X} mod p=(g^{aby} mod p)^{x} mod p=g^{abxy} mod p.

Step 107: After receiving the message M_{AB} sent by party A, party B calculates the session key K_{B}.

K_{B}=(M_{AB})^{y} mod p=(g^{abx} mod p)^{y} mod p=g^{abxy} mod p.

Therefore, the session key of party A and party B is K=KA=KB.

In this embodiment, there is no limitation to the sequence of steps 102, 103, 104, 105, 106, and 107. These steps may be executed in a rearranged sequence or executed simultaneously.

### Embodiment 2

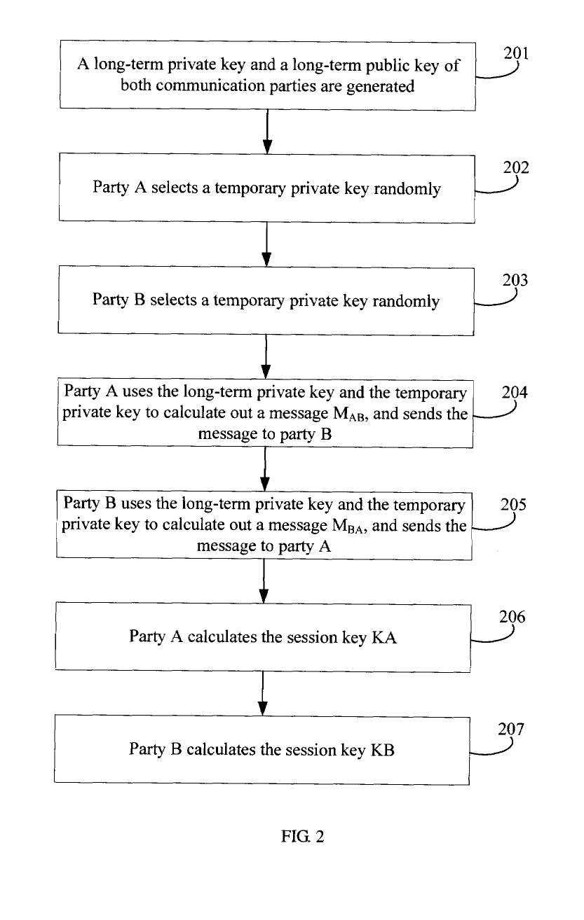

FIG. 2 is a flowchart of a method for generating a session key. In the cryptosystem based on the elliptic curve in this embodiment, the system parameters are T: (u, v, G, n, p), where p is a positive integer, Fp is a finite field, u and v are positive integers on the Fp, G is a basic point on the elliptic curve E (Fp), and n is a prime number and is the order of the basic point G.

The method for generating the session key between party A and party B includes:

Step 201: The key management center generates the long-term private key “a” of party A, long-term private key “b” of party B, long-term public key of party A: P_{A}=a*G mod p, and long-term public key of party B: P_{B}=b*G mod p, and sends a and b to party A and party B, respectively, in a secure mode.

Step 202: Party A selects a temporary private key “x” randomly, and stores it secretly.

Step 203: Party B selects a temporary private key “y” randomly, and stores it secretly.

Step 204: Party A calculates M_{AB}=a*x*(PB) mod p=a*x*(b*G) mod p, and sends the message M_{AB} to party B.

Step 205: Party B calculates M_{BA}=b*y* (PA) mod p=b*y*(a*G) mod p, and sends the message M_{BA} to party A.

Step 206: After receiving the message M_{BA} sent by party B, party A calculates the session key K_{A}.

K_{A}=(M_{BA})^{x} mod p=x*(b*y*(a*G) mod p) mod p=abxy*G mod p.

Step 207: After receiving the message M_{AB} sent by party A, party B calculates the session key K_{B}.

K_{B}=(M_{AB})^{y} mod p=y*(a*x*(b*G) mod p) mod p=abxy*G mod p.

Therefore, the session key of party A and party B is K=KA=KB.

In this embodiment, there is no limitation to the sequence of steps 202, 203, 204, 205, 206, and 207. These steps may be executed in a rearranged sequence or executed simultaneously.

### Embodiment 3

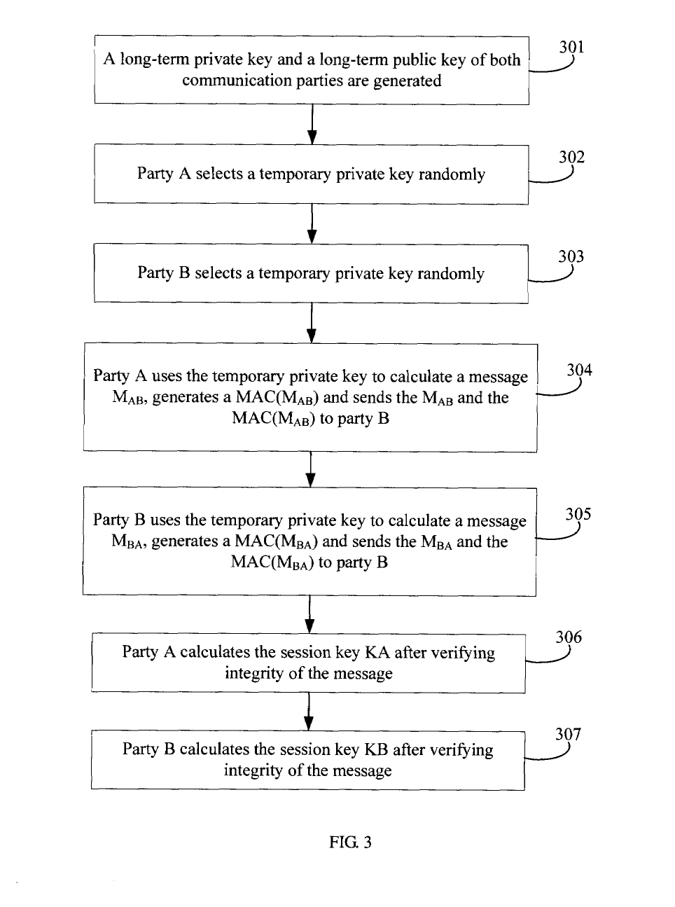

FIG. 3 is a flowchart of a method for generating a session key. In the cryptosystem based on the discrete logarithm in this embodiment, the system parameter T={g, p}, where p is a prime number, g is a generator of the finite field Fp, and g is smaller than p.

The method for generating the session key between party A and party B includes:

Step 301: The key management center generates the long-term private key “a” of party A, long-term private key “b” of party B, long-term public key of party A: PA=ga mod p, and long-term public key of party B: PB=gb mod p, and sends a and b to party A and party B, respectively, in a secure mode.

Step 302: Party A selects a temporary private key “x” randomly, and stores it secretly.

Step 303: Party B selects a temporary private key “y” randomly, and stores it secretly.

Step 304: Party A calculates M_{AB}=gx mod p and s=(PB) a mod p=gab mod p, and uses s to generate the Message Authentication Code (MAC) of the message M_{AB}, namely, MAC (M_{AB}). Party A sends the message M_{AB}and the MAC (M_{AB}) to party B.

Step 305: Party B calculates M_{BA}=gy mod p and s=(PA) b mod p=gab mod p, and uses s to generate the MAC of the M_{BA}, namely, MAC (M_{BA}). Party B sends the message M_{BA} and the MAC (M_{BA}) to party A.

Step 306: After receiving the message M_{BA} sent by party B, party A checks integrity of the M_{BA} according to the MAC (M_{BA}). If the integrity check succeeds, party A calculates the session key KA.

KA=(M_{BA})a*(PB)x mod p=(gay mod p)*(gbx mod p) mod p=gay+bx mod p.

Step 307: After receiving the message M_{AB} sent by party A, party B checks integrity of the M_{AB} according to the MAC (M_{AB}). If the integrity check succeeds, party B calculates the session key KB.

KB=(M_{AB})b*(PA)y mod p=(gbx mod p)*(gay mod p) mod p=gay+bx mod p.

Therefore, the session key of party A and party B is K=K_{A}=K_{B}.

In this embodiment, there is no limitation to the sequence of steps 302, 303, 304, 305, 306, and 307. These steps may be executed in a rearranged sequence or executed simultaneously.

### Embodiment 4

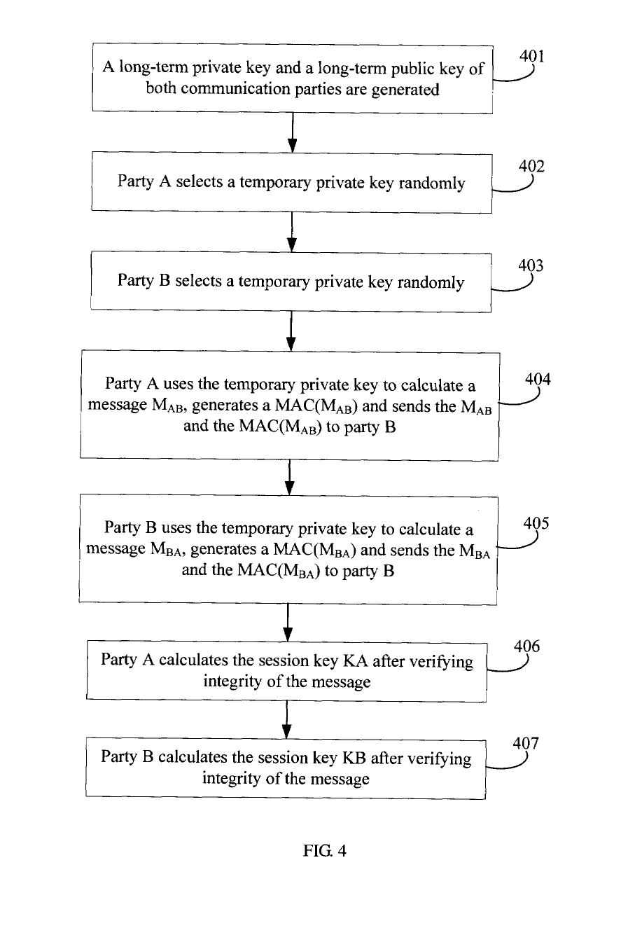

FIG. 4 is a flowchart of a method for generating a session key. In the cryptosystem based on the elliptic curve in this embodiment, the system parameters are T: (u, v, G, n, p), where p is a positive integer, Fp is a finite field, u and v are positive integers on the Fp, G is a basic point on the elliptic curve E (Fp), and n is a prime number and is the order of the basic point G.

The method for generating the session key between party A and party B includes:

Step 401: The key management center generates the long-term private key “a” of party A, long-term private key “b” of party B, long-term public key of party A: P_{A}=a*G mod p, and long-term public key of party B: P_{B}=b*G mod p, and sends a and b to party A and party B in a secure mode respectively.

Step 402: Party A selects a temporary private key “x” randomly, and stores it secretly.

Step 403: Party B selects a temporary private key “y” randomly, and stores it secretly.

Step 404: Party A calculates M_{AB}=x*G mod p and s=a*(P_{B}) mod p=ab*G mod p, and uses s to generate the MAC of the M_{AB}, namely, MAC (M_{AB}). Party A sends the message M_{AB} and the MAC (M_{AB}) to party B.

Step 405: Party B calculates M_{BA}=y*G mod p and s=b*(PA) mod p=ab*G mod p, and uses s to generate the MAC of the M_{BA}, namely, MAC (M_{BA}). Party B sends the message M_{BA} and the MAC (M_{BA}) to party A.

Step 406: After receiving the message M_{BA} sent by party B, party A checks integrity of the M_{BA} according to the MAC (M_{BA}). If the integrity check succeeds, party A calculates the session key K_{A}.

K_{A}=(a*(M_{BA})+x*P_{B}) mod p=(ay+bx)*G mod p.

Step 407: After receiving the message M_{AB} sent by party A, party B checks integrity of the M_{AB} according to the MAC (M_{AB}). If the integrity check succeeds, party B calculates the session key K_{B}.

K_{B}=(b*(M_{AB})+y*P_{A}) mod p=(bx+ay)*G mod p.

Therefore, the session key of party A and party B is K=KA=KB.

In this embodiment, there is no limitation to the sequence of steps 402, 403, 404, 405, 406, and 407. These steps may be executed in a rearranged sequence or executed simultaneously.

In the foregoing embodiment, the process of generating a session key generally involves use of these parameters: long-term private key of the communication party, public key of the opposite party (inclusive of the long-term private key of the opposite party), temporary private key of the communication party, and the message generated by the opposite party (inclusive of the temporary private key of the opposite party). However, the generation of the session key is not limited to the foregoing method. Here is another exemplary method:

(1) Party A generates a message M_{AB} through calculation according to the temporary private key “x” and the long-term private key “a”, for example, M_{AB}=g^{ax} mod p, and sends the message to party B. Likewise, party B generates a message M_{BA} through calculation according to the temporary private key “y” and the long-term private key “b”, for example, M_{BA}=g^{by} mod p, and sends the message to party A.

After receiving the message M_{BA} sent by party B, party A calculates K_{A}=(M_{BA})^{ax} mod p=g^{abxy} mod p according to the message M_{BA}, the long-term private key “a” and the temporary private key “x”.

After receiving the message M_{AB} sent by party A, party B calculates K_{B}=(M_{AB})^{by} mod p=g^{abxy} mod p according to the message M_{AB}, the long-term private key “b” and the temporary private key “y”.

(2) Party A generates a message M_{AB} through calculation according to the temporary private key “x”, long-term private key “a”, and long-term public key of party B (namely, P_{B}), for example, M_{AB}=(P_{B})^{ax} mod p=(g^{b} mod p)^{ax}=g^{abx} mod p, and sends the message to party B. Likewise, party B generates a message M_{BA} through calculation according to the temporary private key “y”, long-term private key “b”, and long-term public key of party A (namely, P_{A}), for example, M_{BA}=g^{aby} mod p, and sends the message to party A.

After receiving the message M_{BA} sent by party B, party A calculates K_{A}=(M_{BA})^{ax} mod p=g^{abxy} mod p according to the message M_{BA} and the temporary private key “x”.

After receiving the message M_{AB} sent by party A, party B calculates K_{B}=(M_{AB})^{by} mod p=g^{abxy} mod p according to the message M_{AB} and the temporary private key “y”.

### Embodiment 5

FIG. 5 shows a structure of a system for generating a session key. A system for generating a session key is provided in an embodiment of the disclosure. The system is a cryptosystem, and includes: a key management center adapted to: generate a long-term public key and a long-term private key according to the parameters of the cryptosystem, and send the long-term private key to the communication device securely; and a communication device adapted to: select a temporary private key, operate at least the temporary private key according to the parameters of the cryptosystem to generate a local message, send the local message to the opposite communication device, and operate at least the received opposite message and the temporary private key according to the parameters of the cryptosystem to generate a session key, where the opposite message is generated by the opposite communication device after at least the temporary private key selected by the opposite communication device is operated according to the parameters of the cryptosystem.

The communication device includes: a temporary private key selecting unit adapted to select a temporary private key; a message generating and sending unit adapted to: operate at least the temporary private key selected by the temporary private key selecting unit according to parameters of the cryptosystem to generate a local message, and send the local message to the opposite communication device; and a session key generating unit adapted to: operate at least the received opposite message and the temporary private key selected by the temporary private key selecting unit according to the parameters of the cryptosystem to generate a session key, where the opposite message is generated by the opposite communication device after at least the temporary private key selected by the opposite communication device is operated according to the parameters of the cryptosystem.

The communication device in this embodiment may select a temporary private key randomly, and the opposite communication device may also select the temporary private key randomly.

The system may be a cryptosystem based on the discrete logarithm or based on the elliptic curve. Moreover, the long-term public key generated by the key management center is obtained from mapping according to the identifier of the communication device.

This embodiment supposes that the cryptosystem is a cryptosystem based on the discrete logarithm. Two communication devices “A” and “B” exist in the system. The system parameter T={g, p}, where p is a prime number, g is a generator of the finite field Fₚ, and g is smaller than p.

The key management center generates the long-term private key “a” of party A, long-term private key “b” of party B, long-term public key of party A: P_{A}=g^{a} mod p, and long-term public key of party B: P_{B}=g^{b} mod p, and sends a and b to party A and party B in a secure mode respectively.

Party A selects the temporary private key “x” randomly through the temporary private key selecting unit, and stores it secretly. Party B selects the temporary private key “y” randomly through the temporary private key selecting unit, and stores it secretly.

Party A calculates M_{AB}=g^{x} mod p through the message generating and sending unit, and sends a message M_{AB} to party B.

Party B calculates M_{BA}=g^{y} mod p through the message generating and sending unit, and sends a message M_{BA} to party A.

After receiving the message M_{BA} sent by party B, party A calculates the session key K_{A} through the session key generating unit.

K_{A}=(M_{BA})^{a}*(P_{B})^{x} mod p=(g^{ay} mod p)*(g^{bx} mod p) mod p=g^{ay+bx} mod p.

After receiving the message M_{AB} sent by party A, party B calculates the session key K_{B} through the session key generating unit.

K_{B}=(M_{AB})^{b}*(P_{A})^{y} mod p=(g^{bx} mod p)*(g^{ay} mod p) mod p=g^{ay+bx} mod p.

Therefore, the session key of party A and party B is K=K_{A}=K_{B}.

### Embodiment 6

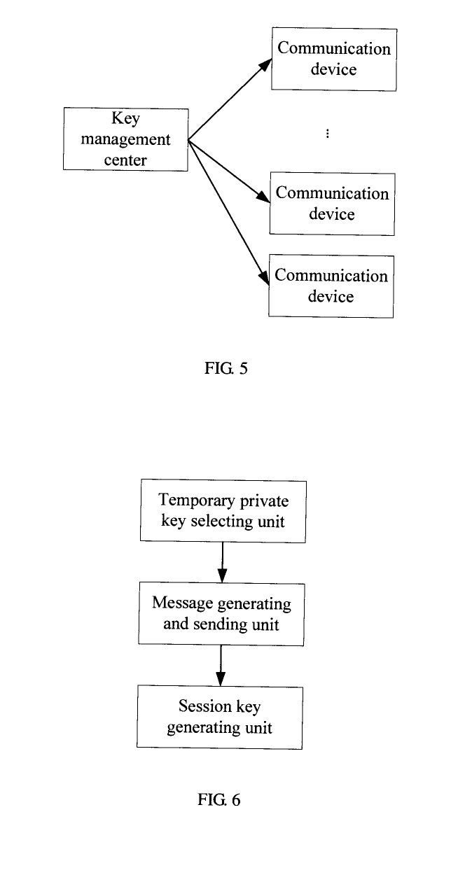

FIG. 6 shows a structure of the communication device provided in an embodiment of the disclosure. The communication device is based on a cryptosystem, and includes: a temporary private key selecting unit adapted to select a temporary private key; a message generating and sending unit adapted to: operate at least the temporary private key selected by the temporary private key selecting unit according to parameters of the cryptosystem to generate a local message, and send the local message to the opposite communication device; and a session key generating unit, adapted to: operate at least the received opposite message and the temporary private key selected by the temporary private key selecting unit according to the parameters of the cryptosystem to generate a session key, where the opposite message is generated by the opposite communication device after at least the temporary private key selected by the opposite communication device is operated according to the parameters of the cryptosystem.

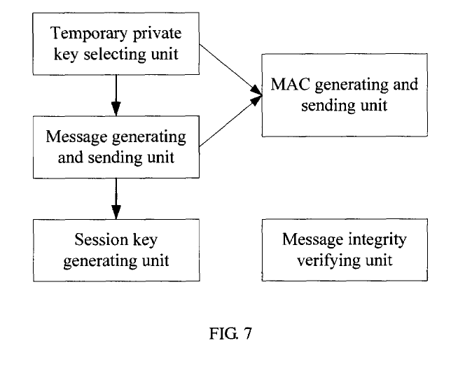

In order to enhance security, as shown in FIG. 7, the communication device further includes: a MAC generating and sending unit adapted to: operate at least the long-term private key stored at the local party and the long-term public key of the opposite communication device according to the parameters of the cryptosystem to generate a MAC of the local message after the message generating and sending unit generates the local message; and send the MAC to the opposite communication device; and a message integrity verifying unit, adapted to: use the MAC of the received opposite message to verify integrity of the received opposite message, where the MAC of the opposite message is generated by the opposite communication device after the long-term public key of the local communication device and the long-term private key of the opposite communication device are operated according to the parameters of the cryptosystem.

The communication device in this embodiment may select a temporary private key randomly, and the opposite communication device may also select the temporary private key randomly. Besides, the cryptosystem may be a cryptosystem based on the discrete logarithm or based on the elliptic curve.

The technical solution provided in the foregoing embodiments may be implemented through software codes. The software codes may be stored in a computer-readable physical media such as compact disks and hard disks.

In the identifier-based combined key management system in the foregoing embodiments, the session key generated through the temporary private key selected by both communication parties is variable, thus avoiding too much dependence on the key management center, improving the security, and making the identifier-based combined key management method more practicable.

Moreover, a MAC is generated to verify the message integrity, thus further improving the system security.

Although the disclosure has been described through several exemplary embodiments, the disclosure is not limited to such embodiments. It is apparent that those skilled in the art can make various modifications and variations to the disclosure without departing from the spirit and scope of the disclosure. The disclosure is intended to cover the modifications and variations provided that they fall in the scope of protection defined by the following claims or their equivalents.

What is claimed is:

1. A method for generating a session key, wherein the method is based on a cryptosystem and comprises:
selecting, by a first communication party, a first temporary private key;
operating at least the first temporary private key according to parameters of the cryptosystem to generate a first message;
sending the first message to a second communication party;
receiving, by the first communication party, a second message;
operating at least the second message and the first temporary private key according to the parameters of the cryptosystem to generate a first session key, wherein the second message is generated by the second communication party after at least a second temporary private key selected by the second communication party is operated according to the parameters of the cryptosystem.

2. The method for generating a session key according to claim 1,
wherein the second message is generated by the second communication party after the second temporary private key selected by the second communication party, a second private key stored at the first communication party, and a first long-term public key of the first communication party are operated according to the parameters of the cryptosystem, and
wherein operating at least the second message and the first temporary private key according to the parameters of the cryptosystem to generate the first session key further comprises:
generating the first session key by operating the second message and the first temporary private key according to the parameters of the cryptosystem.

3. The method for generating a session key according to claim 1,
wherein the second message is generated by the second communication party after the second temporary private key is selected by the second communication party, and
wherein operating at least the second message and the first temporary private key to generate the first session key according to the parameters of the cryptosystem further comprises:
generating the first session key by operating the second message, the first temporary private key, and a first long-term private key stored by the first communication party, and a second long-term public key of the second communication party according to the parameters of the cryptosystem.

4. The method for generating a session key according to claim 1, wherein the cryptosystem is based on one of a discrete logarithm or an elliptic curve.

5. The method for generating a session key according to claim 2, wherein the first long-term public key is obtained from mapping according to an identifier of the communication party.

6. The method for generating a session key according to claim 1, wherein after the first communication party selects the first temporary private key and generates the first message by operating at least the first temporary private key according to the parameters of the cryptosystem, the method further comprises:
generating a first Message Authentication Code (MAC), by operating the second long-term public key of the second communication party and the first long-term private key of the first communication party according to the parameters of the cryptosystem, and sending the first MAC to the second communication party; and
receiving, after the first communication party receives the second message, a second MAC and using the second MAC to verify integrity of the second message, wherein the second MAC is a MAC of the second message and is generated by the second communication party after the first long-term public key of the first communication party and the second long-term private key of the second communication party are operated according to the parameters of the cryptosystem.

7. The method for generating a session key according to claim 1, wherein selecting, by the first communication party, the first temporary private key further comprises:
selecting the first temporary private key randomly.

8. The method for generating a session key according to claim 1, wherein the second temporary private key is selected by the second communication party randomly.

9. A system for generating a session key, wherein the system is a cryptosystem and comprises:
a key management center adapted to generate a long-term public key and a long-term private key according to parameters of the cryptosystem, and send the long-term private key to a first communication device; and
the first communication device adapted to select a temporary private key, operate at least the temporary private key according to the parameters of the cryptosystem to generate a first message, send the first message to a second communication device, and operate at least a received second message and the temporary private key according to the parameters of the cryptosystem to generate the session key, wherein the second message is generated by the second communication device after at least the temporary private key selected by the second communication device is operated according to the parameters of the cryptosystem.

10. The system for generating a session key according to claim 9, wherein the first communication device comprises:
a temporary private key selecting unit adapted to select the temporary private key;
a message generating and sending unit adapted to operate at least the temporary private key selected by the temporary private key selecting unit according to the parameters of the cryptosystem to generate the local message, and send the local message to the opposite communication device; and
a session key generating unit adapted to operate at least the received opposite message and the temporary private key selected by the temporary private key selecting unit according to the parameters of the cryptosystem to generate the session key, wherein the opposite message is generated by the opposite communication device after at least the temporary private key selected by the opposite communication device is operated according to the parameters of the cryptosystem.

11. A communication device based on a cryptosystem, the device comprising:
a temporary private key selecting unit adapted to select a temporary private key;
a message generating and sending unit adapted to operate at least the temporary private key selected by the temporary private key selecting unit according to parameters of the cryptosystem to generate a local message, and send the local message to an opposite communication device; and
a session key generating unit adapted to operate at least a received opposite message and the temporary private key selected by the temporary private key selecting unit according to the parameters of the cryptosystem to generate a session key, wherein the opposite message is generated by the opposite communication device after at least the temporary private key selected by the opposite communication device is operated according to the parameters of the cryptosystem.

12. The communication device of claim 11, further comprising:
a Message Authentication Code (MAC) generating and sending unit adapted to operate at least a long-term private key stored in the communication device and a long-term public key of the opposite communication device according to the parameters of the cryptosystem to generate a MAC of the local message after the message generating and sending unit generates the local message, and send the MAC to the opposite communication device; and
a message integrity verifying unit adapted to use a MAC of the received opposite message to verify integrity of the received opposite message, wherein the MAC of the opposite message is generated by the opposite communication device after the long-term public key of the local communication device and the long-term private key of the opposite communication device are operated according to the parameters of the cryptosystem.
